(19) United States
(12) Patent Application Publication
(10) Pub. No.: US 2008/0283031 A1
(43) Pub. Date: Nov. 20, 2008

(54) Tripod griddle

(76) Inventor: David Korab, Park Falls, WI (US)

Correspondence Address: THE INVENTORS NETWORK, INC., 332 ACADEMY STREET, CARNEGIE, PA, 15106, US

(21) Appl. No.: 11/804,322

(22) Filed: May 18, 2007

(51) Int. Cl. A47J 37/07

(52) U.S. Cl. 126/30

(57) ABSTRACT

A tripod griddle for cooking food over an open fire at, for example, a campsite and which is suspended from a support extending above the fire includes a primary support ring that is slipped onto the support, a plurality of chains pendent from the primary support ring at the upper ends of the chains and the chains being attached to corresponding attachment rings at their opposite lower ends and the attachment rings connected to the respective distal ends of support straps that are radially mounted to the underside of a griddle thereby supporting the griddle above the open fire.

### FIELD OF THE INVENTION

The present invention pertains to outdoor cooking equipment, and more particularly pertains to a portable tripod cooking griddle.

### BACKGROUND OF THE INVENTION

One of the most enjoyable and pleasurable activities when camping is cooking on some type of grill over an open fire. Such cooking allows one to experience aromas, tastes, and flavors of foods that are not possible to obtain from cooking on conventional gas or electric ovens at one's home or residence. Food simply tastes better when cooked over an open fire. Thus, campers have a wide range of cooking equipment from which to choose. Such equipment can be nothing more than a simple grate placed upon the fire ring for supporting over the fire to elaborate griddles that require some effort to set up, take down, and clean. Because of such considerations as available packing space and the time one wants to allot for the unpleasant chore of cleaning after the morning breakfast or evening meal, campers desire cooking equipment that is easy to set up, allows the food items to be cooked in a controlled and regulated fashion, and is easy to clean and store.

For example, the Boda patent (U.S. Pat. No. 4,024,851) discloses a tripod cooking device that includes a pair of legs and a third relatively larger diameter leg with the larger diameter leg capable of receiving and storing therein the smaller pair of legs. A grill assembly is pendent from the larger diameter leg by cables that are attachable at various vertical locations on the larger diameter leg.

The Manska patent (U.S. Pat. No. 4,146,010) discloses an outdoor grill tripod that includes elongated members each of which has a chain link attached thereto for supporting a centrally suspended grill.

The Gehrke patent (U.S. Pat. No. 4,726,349) discloses a portable grill device that includes three elongated members that support a hexagonal shaped firebox with the elongated members joined at their upper ends by a joint plate from which a kettle can be suspended.

The Gilbert patent (U.S. Pat. No. 5,713,344) discloses a portable cooking grill that includes four upright support rods to which a grill is slidably mounted by support elements.

The Taylor et al. patent (U.S. Pat. No. 5,850,829) discloses an adjustable grill stand that includes a plurality of legs interconnected at their upper ends by a disk through which a cross bar extends with the crossbar including a plurality of hangers from which utensils can be hung.

The Robertson patent (U.S. Pat. No. 6,711,993 B2) discloses a camp stove and barbeque system that supports at various intervals such items as a grill surface, a warming rack, a heat source, a potholder, and a utensil arm.

Nonetheless, despite the ingenuity of the above devices, there remains a need for a portable tripod griddle that can be easily suspended from any type of support over a fire for warming liquids and cooking food.

### SUMMARY OF THE INVENTION

The present invention comprehends a portable tripod griddle that is used for cooking food over an open fire in outdoor camping settings and environments. The tripod griddle includes a circular griddle or pan having a cooking surface and an opposite underside. The griddle is further defined by a peripheral rim that prevents the food from sliding off the griddle should the griddle be bumped or jostled. Mounted to the underside of the griddle are three support straps having distal ends that project slightly past the rim, with the distal end of each support strap including an aperture. Inserted through each aperture is a lower attachment ring while a primary support ring is slipped onto an overhead support like a tree limb. Interconnected to and extending from the primary support ring are three chain comprised of a series of interconnected oblong links with the lowermost link of each chain connected to each corresponding lower attachment ring. The lengths of the chains are sufficient to appropriately suspend the griddle above the fire, and the chains are sufficiently spaced from each other to allow access to the food by various utensils. The primary ring and the lower attachment rings can also include an embodiment wherein their ends are overlapping and separable so that the chains can be removed therefrom thereby facilitating cleaning of the griddle and breakdown of the tripod griddle for storage and transport.

It is an objective of the present invention to provide a tripod griddle that cooks food quickly and efficiently and is easy to clean.

It is another objective of the present invention to provide a tripod griddle that is lightweight, portable and manufactured from durable stainless steel.

It is yet another objective of the present invention to provide a tripod griddle wherein the griddle includes a peripheral lip for preventing food items from sliding off the griddle.

It is still yet another objective of the present invention to provide a tripod griddle that allows the individual cooking the food to regulate the amount of heat contacting the griddle.

These and other objects, features, and advantages will become apparent to those skilled in the art upon a perusal of the following detailed description read in conjunction with the accompanying drawings and the appended claims.

### BRIEF DESCRIPTION OF THE DRAWINGS

FIG. 1 is a perspective view of the tripod griddle of the present invention illustrating the suspension of the tripod griddle from a tree limb;

FIG. 2 is a perspective view of the tripod griddle of the present invention;

FIG. 3 is a bottom plan view of the tripod griddle of the present invention;

FIG. 4 is a top plan view of the tripod griddle of the present invention illustrating an alternative embodiment for the one-inch diameter attachment rings;

FIG. 5 is a top plan view of the tripod griddle of the present invention illustrating the separation of the overlapping ends of the attachment ring shown in FIG. 7 so that the ring can be removed from the support strap or the lowermost link of the chain;

FIG. 6 is a top plan view of the tripod griddle of the present invention illustrating an alternative embodiment for the two inch diameter primary support ring; and

FIG. 7 is a top plan view of the tripod griddle of the present invention illustrating the separation of the overlapping ends of the two-inch diameter primary support ring can be removed from the uppermost links of the chains.

### DETAILED DESCRIPTION OF THE PREFERRED EMBODIMENT

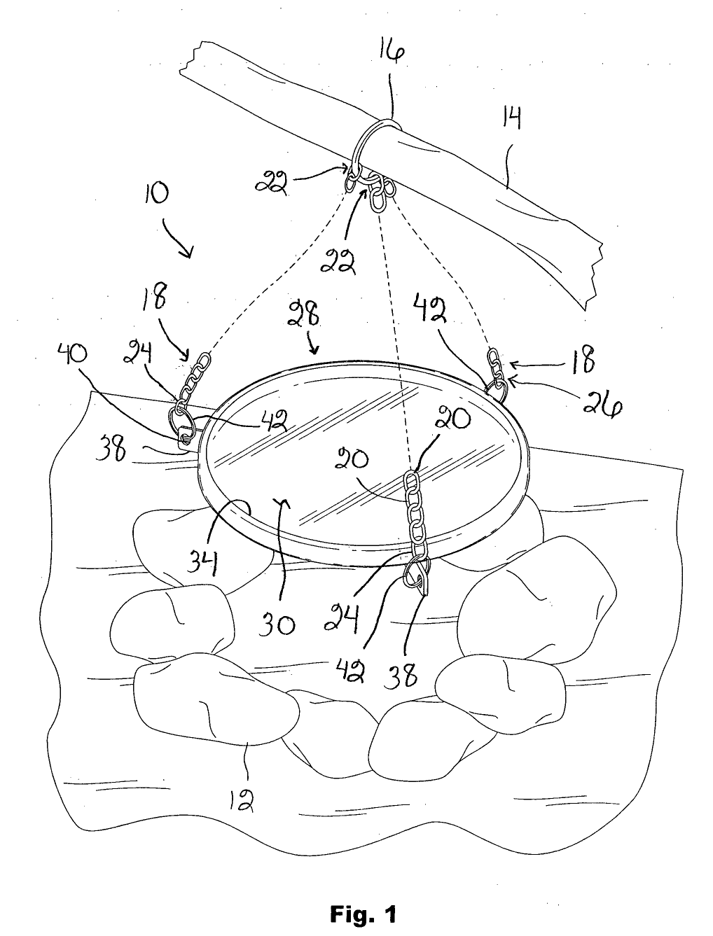

Illustrated in FIGS. 1-7 is a tripod griddle 10 for cooking various types of food items such as hamburgers, hot dogs, steak, chicken, potatoes, beans, eggs, bacon, ham, etc., over an open fire. The tripod griddle 10 is especially designed for outdoor cooking over an open campfire 12, as shown in FIG. 1, common on camping trips and excursions. The tripod griddle 10 is lightweight, portable, durable (all structural components are manufactured from high grade stainless steel), and is easy to set up and easy to clean. The tripod griddle 10 is adapted for suspension from above the fire and from an overhead support, with the overhead support being a tree limb 14 as shown in FIG. 1. The tripod griddle 10 is thus disposed pendent from the overhead support.

The tripod griddle 10 includes a two-inch diameter primary support ring 16 that can be slipped onto and slipped off of the overhead support such as the tree limb 14 of FIG. 1. Attached to the primary support ring 16 is a plurality (preferably three) of chains 18 with each chain 18 comprised of a plurality of interconnected oblong flat chain links 20. The chain links 20 for each chain 18 are further defined by having an uppermost link 22 and an opposite lowermost link 24. One preferred length for each chain 18 is 18 inches.

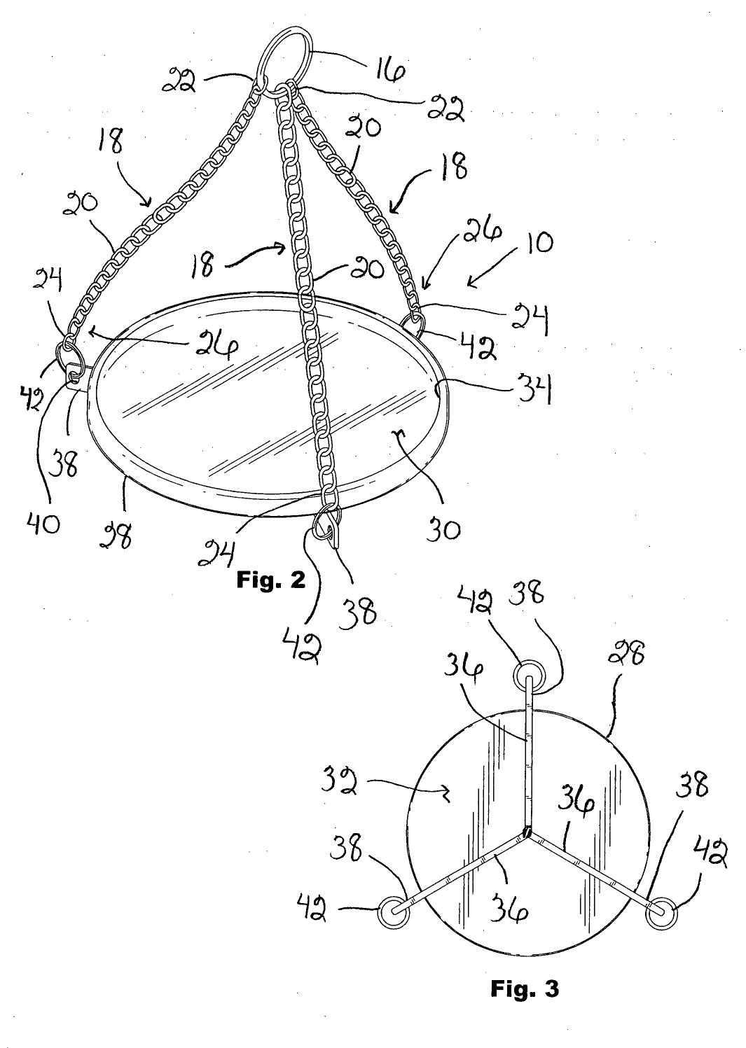

As shown in FIGS. 1 and 2, the chains 18 attach at their respective lower ends 26 to a griddle or pan 28. The griddle 28 includes a generally flat interior cooking surface 30 and an opposite underside 32 that is in direct contact with the heat of the campfire 12. In addition, the griddle 28 includes a peripheral upwardly extending rim or lip 34 that prevents any food items from slipping or sliding off the interior cooking surface 30 should the griddle 28 be jostled or bumped. One preferred dimension for the griddle 28 is for the griddle 28 to have an outside diameter of 24 inches and an inside diameter of 23 inches.

As shown in FIGS. 1-3, mounted to the underside 32 of the griddle 28, preferably by being welded thereto, are three radially extending support straps 36. Each support strap 36 includes a distal end 38 that projects slightly past the peripheral rim 34 of the griddle 28, and each distal end 38 includes an aperture 40. Insertable through each aperture 40 of each distal end 38 of each support strap 36 for interconnection to the lowermost link 24 of each chain 18 is a lower attachment ring 42. The lower attachment rings 42 are preferably one inch in diameter. The lower attachment rings 42 thus provide the connection between the griddle 28 and the chains 18.

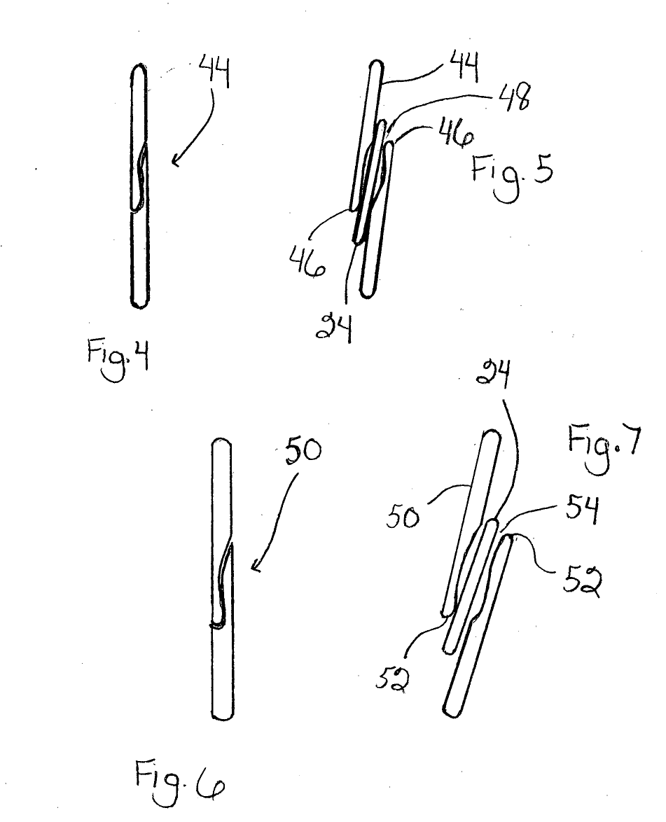

Illustrated in FIGS. 4-7 are alternative embodiments for the attachment rings and the primary support ring shown in FIGS. 1-3, with these embodiments allowing for the disassembly and removal of the chains 18 from the griddle 28 and the primary support ring thereby facilitating the cleaning, break down, storage and transport of the tripod griddle 10. Specifically, FIGS. 4 and 5 illustrate an attachment ring 44 that includes a pair of flexible, overlapping, and mating ends 46 that close upon each other for securing each attachment ring 44 to each respective strap 36 and the respective lowermost link 24 while in FIG. 5 the overlapping ends 46 are shown being drawn or pried slightly apart creating an opening or gap 48 so that the attachment ring 42 can be slipped off of the lowermost link 24, or, if desired, the distal end 38 of one or more straps 36. FIGS. 6 and 7 illustrate a primary support ring 50 that includes a pair of flexible, overlapping mating ends 52 that mate for holding the chains 18 on the primary support ring 50; and, as shown in FIG. 7, the overlapping ends 52 can be drawn slightly apart thereby creating a gap or opening 54 that allows the uppermost link 22 of one or more of the chains 18 to pass through the opening 54 so that one or more of the chains 18 can be removed from the primary support ring 50. Such disassembly makes cleaning the various components of the tripod griddle 10 much easier and efficient. Such disassembly is also desirable if any of the links 20 of the chains 18 become damaged and repair or replacement is necessary.

The foregoing is considered as illustrative only of the principles of the invention, and since numerous modifications, alterations, and variations are considered readily apparent and obvious to those skilled in the art, it is not desired to limit the invention to the exact construction and operation as shown and described but, accordingly, all suitable, appropriate, and desirable modifications, alterations, variations, and changes that may be conceived of and resorted to are considered to fall within the ambit of the invention.

I claim:

1. A tripod griddle for suspension above a campfire from an overhead support, comprising:
a primary support ring for placement upon the overhead support;
a plurality of chains attached to the primary support ring and pendent therefrom;
each chain having an uppermost link and an opposite lower end;
a plurality of lower attachment rings with each lower attachment ring secured to the lower end of the corresponding chain;
a griddle for disposition above the campfire and the griddle having an interior cooking surface, an opposite underside and a peripheral rim;
a plurality of support straps mounted to the underside of the griddle with the support straps radially extending along the underside and each strap including a distal end that projects slightly past the rim;
each distal end of each strap including an aperture; and
wherein the lower attachment rings are inserted through the corresponding apertures for interconnecting the griddle to the chains so that the griddle is disposed pendent from the overhead support and above the campfire.

2. The tripod griddle of claim 1 wherein the primary support ring includes a pair of opposed flexible overlapping ends that are drawn together when securing the griddle above the campfire and can be separated to facilitate the disassembly of the tripod griddle.

3. The tripod griddle of claim 2 wherein each lower attachment ring includes a pair of opposed flexible overlapping ends that come together when the tripod griddle is assembled and can be drawn apart for removing the lower attachment rings from the corresponding chains and support straps.

4. A tripod griddle for suspension from an overhead support and above a campfire for cooking food thereon, comprising:
a primary support ring for placement upon the overhead support;
a plurality of chains attached to the primary support ring and pendent therefrom;
a plurality of lower attachment rings with each lower attachment ring secured to each corresponding chain;
a griddle attached to the chains for disposition above the campfire;
the griddle including an interior cooking surface for cooking the food, an opposite underside and a peripheral rim;
a plurality of support straps mounted to the underside of the griddle with the support straps radially extending along the underside and each support strap including a distal end that projects slightly pas the rim;
the distal end of each support strap including an aperture; and
wherein the lower attachment rings are insertable through the corresponding apertures and attachable to the chains for supporting the griddle above the campfire and pendent from the overhead support.

5. The tripod griddle of claim 4 wherein each chain includes an uppermost link, a lowermost link, and a lower end.

6. The tripod griddle of claim 5 wherein the primary support ring includes a pair of opposed flexible overlapping ends that are drawn together when the griddle is secured to the chains for disposition above the campfire and are separable from each other to facilitate the disassembly of the tripod griddle.

7. The tripod griddle of claim 6 wherein each lower attachment ring includes a pair of opposed flexible overlapping ends that are closed upon each other when the griddle is disposed above the campfire and which can be drawn apart for removal of the griddle and the chains from the lower attachment rings.
